(19) United States
(12) Patent Application Publication
(10) Pub. No.: US 2005/0287385 A1
(43) Pub. Date: Dec. 29, 2005

(54) Paperboard material having increased strength and method for making same

(76) Inventor: Thomas H. Quick, Winfield, IL (US)

Correspondence Address: Patrick W. Rasche;Armstrong Teasdale LLP, Suite 2600, One Metropolitan Square, St. Louis, MO, 63102, US

(21) Appl. No.: 10/878,882

(22) Filed: Jun. 28, 2004

(51) Int. Cl. C08F 265/04; B32B 23/08

(52) U.S. Cl. 428/507

(57) ABSTRACT

A paperboard material having increased strength comprising a strengthening agent at least partially impregnated into at least one of the first and second sides of the paperboard material while the paperboard material is substantially dry, and a method for making same. The strengthening agent comprises a small particle size styrene butadiene resin having a particle size of less than or equal to about 1000 angstroms, and more preferably about 700 angstroms or less. The strengthening agent may also include a stiffening additive having a higher glass transition temperature than the styrene butadiene resin, such as a small particle size polymer resin, preferably a polystyrene pigment have a particle size of 700 angstroms or less. The strengthening agent is preferably applied to the paperboard material during the dry end of the process. To this end, the strengthening agent is preferably impregnated into the paperboard material by a size press, or other standard paper sizing equipment.

### BACKGROUND OF THE INVENTION

1. Field of the Invention

The present invention relates in general to paperboard materials having increased strength, and more particularly, to a paperboard material impregnated with a small particle size styrene butadiene resin while the paper is substantially dry to increase the strength of the paperboard material, together with a method for making same.

2. Background Art

Sizing agents and other strengthening agents have been used to strengthen various paperboard materials for years. For instance, wax has been used to stiffen paperboard materials, as well as to provide water repellency to paperboard materials, such a linerboard, corrugating medium, corrugated board, carton board and others. However, wax tends to have poor repulpability, and thus poor performance when wax coated or wax impregnated paperboard materials are recycled. Additionally, wax tends to have higher costs than are preferred for certain sizing applications.

Starch is also commonly used as a sizing agent in many paperboard applications. While starch is much less expensive than wax, it too has undesirable characteristics. In particular, starch does not possess good water repellency properties, and thus the integrity of starch impregnated and/or coated paperboard materials is not adequately maintained in applications where high humidity and water resistance is important.

Many other different approaches to sizing paperboard materials have also been employed. For instance, it has been a common practice to mix various sizing agents or strengthening additives with cellulosic fibers in the wet end of paper manufacturing processes, so that those additives are incorporated directly into the paper fibers during formation of a fibrous web. Various sizing or strengthening additives have been used in wet end processing, including starch, rosin and various latex, rubber and polymeric materials. For instance, Huebner, et al., U.S. Pat. No. 3,937,648 discloses the wet end addition of latex resin particles to paper pulp, wherein the resin particles are approximately 0.01 to 1 microns in particle size. A cationic dispersing agent is also added to increase the amount of bonding between the resin and the paper pulp, such that a greater amount of the resin is incorporated into the final paper product. Amongst those latex resin particles disclosed for use with the invention of Huebner et al. is styrene butadiene.

Likewise, many other prior art references show that various latexes, including styrene butadiene resins, have been incorporated as sizing agents into the wet end of paper making processes for years. That practice is disclosed in Owen, U.S. Pat. No. 2,474,801, Horsey, et al., U.S. Pat. No. 2,650,153, Feigley, U.S. Pat. No. 2,772,970, Engel et al., U.S. Pat. No. 2,899,353, Martin, U.S. Pat. No. 3,063,950, Great Britain Patent No. 837,589, Canadian Patent No. 617,086 and Bartelloni, U.S. Pat. No. 4,510,019. These examples of wet end rubber latex addition to the wet pulp stage of paper making processes disclose various formulations and methods for improving impregnation and/or incorporation of sizing agents into the wet fibrous materials.

Natural and synthetic latex materials, including natural and synthetic rubber latex materials, and more particularly including styrene butadiene resins, have also been employed in the paper making industry as binders for paperboard coatings for many years. In particular, coating pigments such as clay are typically suspended in a latex binder, such as styrene butadiene, and are often used to improve printability of paper or to modify various paper characteristics, such as gloss, light absorption and/or light reflection. In particular, coating pigments are typically small particle size molecules, and require suspension in a larger particle size binder to remain on the surface of paperboard materials. Coating pigments which penetrate or are impregnated into the web of fiber materials typically do not achieve the desired surface coating characteristics. Typical binders tend to be in the 1300 angstrom to 10,000 angstrom range (0.13 micron to 1 micron range) to prevent absorption of the pigment into the fibrous material. For instance, styrene butadiene binders are commercially available from Dow Chemical of Midland, Mich. with a particle size of 1300 angstroms for this very purpose. Likewise, BASF of Charlotte, N.C. offers a commercial styrene butadiene latex binder having a particle size of about 1500 to 2000 angstroms.

This practice of using styrene butadiene and other latex polymers as paper coating binders is reflected in various prior art patents. In particular, Fujita et al., U.S. Pat. No. 4,064,304 discloses a pigmented coating for synthetic paper, in which finely divided particles of pigment are suspended in a latex binder, which may comprise styrene butadiene. The particle size of the pigment is approximately 0.1 to 1 microns.

Likewise, Wenzel, et al., U.S. Pat. No. 5,654,039 discloses the use of water-based polymer dispersions, including those employing styrene butadiene, to provide water and grease resistance to paper packing. Wenzel, et al. discloses the use of two coats of the polymer dispersion, a primer coat and a top coat, to impart the desired water and grease repellant characteristics.

As yet another example, JP 3227496 discloses a paper coating composition capable of imparting excellent printing gloss, bond strength and light resistance to coated paper. The coating includes a pigment, with two kinds of latex as a binder. In particular, the coating incorporates 100 parts weight of a paper coating pigment and 5-20 parts weight of (A) a latex having a particle size of 1000-2000 angstroms with a glass transition temperature of 10-20° C. produced by the copolymerization of (1) 29-50 wt. % of an aliphatic conjugated diene compound, (2) 35-37 wt. % of an aromatic vinyl compound, (3) 1-10 wt. % of an ethylene based unsaturated carboxylic acid and (4) 0-20 wt. % of a copolymerizeable ethylene based unsaturated compound and (B) a second latex having a particle size of 300-800 angstroms, with a glass transition temperature of 10°-30° C. produced by the copolymerization of a composition comprising (1) 30-60 wt. % of an aliphatic conjugated diene compound, (2) 35-75 wt. % of an aromatic vinyl compound, (3) 1-5 wt. % of an ethylene based unsaturated carboxylic acid and (4) 0-20 wt. % of a copolymerizeable ethylene based unsaturated compound.

Still others have sized paperboard materials by the impregnation of various additives directly into the paperboard material. For instance, Schennum et al., U.S. Pat. No. 6,194,057, discloses partially impregnating lignocellulosic materials with strengthening agents to increase the overall strength of the lignocellulosic materials, while allowing for one surface of the lignocellulosic materials to remain readily bondable to other adhesive surfaces. In particular, one side of the paper material is impregnated with a strengthening agent selected from a group consisting of lignosulfonate, craft lignin, organosolv, chemically modified lignin derivatives, sodium silicate, starch, xylan, carboxymethyl cellulose, polyvinyl acetate, vinyl polymers, acrylic polymers or mixtures thereof to strengthen the paper material. The additive covers the surface through which it impregnates the paperboard material, and extends to various penetration depths such that some of the opposite surface is covered with the additive. However, some of the non-impregnated surface is not covered by the additive. The non-impregnation surface remains at least partially uncovered by the additive to allow adhesive bondability to a second paperboard material. The depth of penetration, extending at certain points through the entirety of the thickness of the paper material, is achieved through the use of the MIPLY pressure saturator system described in U.S. Pat. No. 4,588,616. While the pressure saturator is preferred because of its ability to drive the strengthening agent into the paper material with relatively high pressure, Schennum also discloses the use of other impregnating machines, such as size presses.

As another example, Tengqvist, U.S. Pat. No. 4,948,448, discloses a method for manufacturing moisture resistant corrugated paperboard including an outer liner, an inner liner and corrugated fluting disposed therebetween. Prior to formation of the corrugated board, the corrugated fluting is impregnated throughout its entire thickness with a suspension including styrene butadiene and starch. The impregnation process is carried out while the paper is still being dried, such that the paper has a dry content of about 50-60%. Tengqvist performs the impregnation while the paperboard is still in the wet end of the process and still substantially wet, as paper with a dry solids content of only about 45-55% is able to absorb the additive suspension more easily. This partial wet impregnation facilitates impregnation throughout the whole thickness of the paper—a much more difficult task when the paper is substantially dry.

While these and other prior art methods for sizing and/or strengthening paperboard materials have worked well, it is desirable to provide a process for impregnating paperboard materials with sizing and/or strengthening agents to improve the strength of the paperboard materials on standard paper making equipment, which can be carried out on the dry end of a paper making process, after the paper is already formed and substantially dry.

It is also desirable to use a styrene butadiene resin as a sizing or strengthening agent in a small particle size, to ensure that most or all of the latex resin does not remain on the surface of the paper, but rather achieves significant penetration into the paperboard material to achieve increased strength.

It is further desired to impregnate paperboard material on the dry end of a paper making process without increasing the caliper or thickness of the paper material. Rather, strengthening with a sizing or strengthening agent is preferably achieved by increasing the basis weight or density of the paper material.

It is still further desirable to increase the stiffness of paperboard materials to improve strength, while at the same time improving repulpability and recyclability.

It is also desirable to achieve sizing of various paperboard materials with a size press or other standard paper making equipment, without having to use specialty pressure saturators, high pressure impregnators or other specialty impregnation equipment.

As a related goal, it is desirable to control the depth of penetration of the strengthening agent to ensure proper sizing of the paperboard material.

### SUMMARY OF THE INVENTION

The present invention is directed to a paperboard material having increased strength and a process for making same. The paperboard material comprises a strengthening agent at least partially impregnated into one or both sides of the paperboard material, while the paperboard material is substantially dry The strengthening agent comprises a small particle size styrene butadiene resin having a particle size of less than or equal to about 1000 angstroms. It has been found that the small particle size styrene butadiene resin impart greater stiffness and strength to paperboard material than standard larger particle size styrene butadiene resins having a particle size of 1300 angstroms or greater.

In a preferred embodiment, the styrene butadiene resin strengthening agent has a particle size of less than or equal to about 700 angstroms, and preferably a particle size of about 700 angstroms. The particle size should be considered with a 100 angstrom standard deviation.

Also in a preferred embodiment, the strengthening agent is impregnated into both the first and second sides of the paperboard material. However, the strengthening agent need only be impregnated into one side of the paperboard material to impart the desired increase in paperboard strength.

Preferably, the strengthening agent does not substantially affect the thickness of the paperboard material as compared to the thickness of the paperboard material without impregnation of the strengthening agent. The strengthening agent does not merely sit on top of the paperboard as a surface coating. However, the strengthening agent preferably increases the density of the paperboard material as compared to the density of the paperboard material without impregnation of the strengthening agent.

In a preferred embodiment, the strengthening agent penetrates at least one of the first and second sides of the paperboard material by about 10% to about 50% of the thickness of the paperboard material. More preferably, the strengthening agent penetrates at least one of the first and second sides of the paperboard material by about 20% to about 50% of the thickness of the paperboard material. In one preferred embodiment, the strengthening agent penetrates at least one of the first and second sides of the paperboard material by about 35% of the thickness of the paperboard material.

The paperboard material may comprises any number of paper materials, but preferably comprises liner board or corrugating medium. The strengthening agent preferably impregnates at least one of the first and second sides of the paperboard material after the front end of a paper making process, when the paperboard material is substantially dry.

In a preferred form, the strengthening agent has a glass transition temperature of about 15° C. to about 20° C. The strengthening agent increases the stiffness of the paperboard material.

In another preferred embodiment, the strengthening agent further comprises a stiffening additive. The stiffening additive preferably comprises a polystyrene resin having a particle size of less than or equal to about 700 angstroms. More preferably, the polystyrene resin is a polystyrene pigment. The stiffening additive preferably has a glass transition temperature of about 70° C. to about 100° C., and more preferably in the range of about 80° C. to about 90° C. In one preferred form, the stiffening additive has a glass transition temperature of about 90° C.

When used in blended form, the strengthening agent preferably comprises about 80% to about 90% by weight of the styrene butadiene resin having a particle size of less than or equal to about 1000 angstroms and about 10% to about 20% by weight of the stiffening additive. However, the stiffening additive may comprise 1 % to about 20% by weight of the strengthening agent blend.

The strengthening agent may also include a water resistance additive. In a preferred embodiment, the water resistance additive is selected from the group consisting of alkyl ketene dimers, rosins and alkyl succinic anhydrides, with an alkyl ketene dimer being preferred. When required, the water resistance additive is preferably present in an amount of about 1 wt. % to about 2 wt. % based upon the dry weight of the styrene butadiene resin.

The present invention is also directed to a method for manufacturing paperboard having increased strength comprising the steps of
impregnating at least one side of a paperboard material having a first side and a second side with a strengthening agent, the first and second sides each having a surface and the paperboard material also having a thickness,
the strengthening agent penetrating at least one side of the paperboard material to a depth below the surface of at least one of the first and second sides,
the step of impregnating the paperboard material occurring after the paperboard material is substantially dry,
wherein the strengthening agent comprises a styrene butadiene resin having a particle size of less than or equal to about 1000 angstroms.

In a preferred embodiment, the step of impregnating the paperboard material occurs after drying the paperboard material on the front end of the paper forming process such that it is substantially dry. Also in a preferred embodiment, the step of impregnating the paperboard material is carried out with a size press, or other standard sizing equipment such as a calendar roll or paper impregnator. The impregnation of the strengthening agent, whether or not including a stiffening additive and/or water resistance additive, can be carried out on either one or both sides of the paperboard material.

During the step of impregnating the paperboard material, the strengthening agent preferably penetrates below the surface of at least one of the first and second sides of the paperboard material, without substantially affecting the thickness of the paperboard material as compared to the thickness of the paperboard material without impregnation of the strengthening agent. Of course, some minimal surface coating may occur, but preferably in an insubstantial amount. Preferably, the strengthening agent penetrates at least one of the first and second sides of the paperboard material by about 10% to about 50% of the thickness of the paperboard material, and more preferably by about 20% to about 50% of the thickness of the paperboard material.

In a preferred embodiment, the method further includes the step of diluting the styrene butadiene resin to a solids loading of about 10 wt. % to about 50 wt. % prior to the step of impregnating the paperboard material with the styrene butadiene resin. More preferably, the styrene butadiene resin is diluted to a solids loading of about 10 wt. % to about 25 wt. % prior to the step of impregnating the paperboard material with the styrene butadiene resin.

### BRIEF DESCRIPTION OF THE DRAWINGS

FIG. 1 is a schematic view of a process for manufacturing paperboard increased strength according the present invention.

### DETAILED DESCRIPTION OF THE INVENTION

While this invention is susceptible of embodiment in many different forms, there are shown in the drawings, and will be described in detail, several specific embodiments with the understanding that the present disclosure is to be considered as an exemplification of the principals of the invention and is not intended to be limited to the embodiments illustrated and/or described.

The present invention is directed to paperboard material having increased strength properties, and a method for making same. It has been found that in contrast to the prior art use of larger particle size latex emulsions for coating paperboard on the dry end of the paper making process, the use of small particle size styrene butadiene resin emulsions having a particle size of less than or equal to about 1000 angstroms provides good sizing penetration and increased strength to paperboard materials with conventional size press paper making equipment.

Notably, while the words “paperboard” or “paperboard materials” are used frequently throughout this specification, the paperboard material may comprise any number of intermediate or final paperboard products, such as liner board, corrugated medium, corrugated board, fiber board and/or carton board, as would be known by those of ordinary skill in the art with the present disclosure before them. Furthermore the terms “strengthening agent” or “strengthening additive” are also used frequently throughout this specification. The term “strengthening” can be used to denote an increase in board stiffness, an increase of the board's resilience to crush resistance or any other measure of strength as would be known by those of ordinary skill in the art with the present disclosure before them. Still further, some of the strengthening agents referred to in the specification below are also commonly referred to as “sizing agents”. Typically, sizing refers to imparting either stiffness or water repellency, or both, to paperboard materials. For purposes of the present specification, sizing agents impart increased stiffness to paperboard materials, and thus function as strengthening agents.

In a first embodiment, the paperboard material is impregnated with a strengthening agent comprising a styrene butadiene resin emulsion. While the paperboard material can be any one of the above mentioned types of paper mediums, the paperboard is preferably either liner board or corrugating medium. Further, the strengthening agent can be impregnated into one or both sides of the paperboard material, depending end use application. If one side of the paperboard material must be adhesively bonded to another paperboard medium, such as linerboard or corrugated medium, it may be desirable to impregnate only one side (the non-bonding side) of the paperboard material. While this may result in decreased overall strength of the paperboard material, it may also eliminate potential problems that may result from impregnating with a latex emulsion, which can be tacky. The use of other additives, or the subsequent treatment of dual sided impregnated paperboard material, may be required if subsequent adhesive bonding is required.

The styrene butadiene resin is preferably applied to the paperboard material as an emulsion. In a preferred embodiment, the emulsion comprises about 10% to about 50% solids, and more preferably about 10% to about 25% solids. The styrene butadiene resin has a particle size of less than or equal to about 1000 angstroms, preferably less than or equal to about 700 angstroms. The styrene butadiene resin further has a glass transition temperature of about 15-20° C. A suitable small particle size styrene butadiene resin can be purchased from Dow Chemical of Midland, Mich. under the brand name XU-31366. Notably, resin emulsions typically have a standard deviation of approximately 100 angstroms in particle size. Thus, a 700 angstrom particle size styrene butadiene resin from Dow Chemical typically contains particle sizes ranging from about 600 angstroms to about 800 angstroms.

Preferably, impregnation of a styrene butadiene resin emulsion into the paperboard material increases the density of the paperboard material, but does not change the thickness of the paper material. Stated another way, the impregnated paper preferably increases in basis weight but not caliper, because of the densification effect of the impregnated latex polymer resin. The increase in paper densification without the increase of the caliper of the paper also demonstrates that the styrene butadiene latex resin latex emulsion does not merely coat the paper, but rather penetrates into the paper from the surface. Complete or nearly complete penetration into the paperboard material is desirable as styrene butadiene, like many latex rubbers, can be tacky if it remains on the surface of the paper. Surface tackiness can decreases the ease of handling the styrene butadiene resin impregnated paper, as rolling the paper material for storage or shipment purposes will result in sticking issues.

The styrene butadiene resin preferably penetrates directly into the thickness of the paperboard material. Preferably, the styrene butadiene resin penetrates each side of the paper material by at least about 10% to about 50% of the paper material thickness, depending on the type of paperboard material used. As would be known by those of ordinary skill with the present disclosure before them, the use of different paperboard materials having different basis weights will result in different degrees of penetration. For example, paperboard with a 23 pound basis weight experiences about 30% to about 50% penetration of the styrene butadiene resin through each side of the board. With 23 pound board, impregnation with small particle size styrene butadiene resin according to the present invention can encompass the entire thickness of the board. In contrast, a thicker board such as 56 pound basis weight paperboard typically experiences about 20% to about 30% penetration of the styrene butadiene resin on each side of the paperboard material. Thus, impregnation of a small particle size styrene butadiene resin according to the present invention into 56 pound board may achieve a total of about 40% to about 60% penetration of the total paperboard thickness.

It has also been found that styrene butadiene resins having a particle size of less than or equal to about 1000 angstroms, and more preferably a particle size of about 700 angstroms, have a significantly higher surface area than styrene butadiene resin particles having a large particle size, such as those resin particles in the range of about 1300 angstroms to about 2000 angstroms. These smaller particle size styrene butadiene resin provides better surface coverage of the paperboard materials, thus resulting in better crevice penetration.

In another embodiment, the strengthening agent comprises a blend of styrene butadiene resin and a stiffening additive. In particular, the stiffening additive is preferably a small particle size polymer having a glass transition temperature higher than that of the styrene butadiene resin emulsion, which has a glass transition temperature of approximately 15-20° C. In a preferred embodiment, the stiffening additive preferably has a particle size of less than or equal to about 700 angstroms, although other particle sizes up to and including about 1000 angstroms are likewise contemplated for use with the present invention. Also in a preferred embodiment, the stiffening additive has a glass transition temperature of about 70-100° C. More preferably, the stiffening agent preferably has a glass transition temperature in the range of 80-90° C., with a 90° C. glass transition temperature in one preferred embodiment. The stiffening additive with such properties may comprise a plastic pigment such as polystyrene or styrene butadiene. A suitable polystyrene plastic pigment may be obtained in a blended product (polystyrene plastic pigment blended with styrene butadiene resin) from Dow Chemical in Midland, Mich. sold under the product number 134996B. However, other small particle size polymers resins or polymer pigments having a glass transition temperature in the ranges specified can also be used with the present invention, as would be known by those of ordinary skill in the art with the present disclosure before them.

Preferably, the styrene butadiene resin emulsion comprises approximately 80-99% of the strengthening agent composition, while the stiffening additive comprises approximately 1-19% of the strengthening agent composition. Preferably, the stiffening additive comprises approximately 10-20% of the strengthening agent blend, while the styrene butadiene resin comprises preferably approximately 80-90% of the blend, on a dry weight basis.

It has been found that the stiffening additive with a higher glass transition temperature is more brittle than the styrene butadiene resin upon incorporation into the paperboard material, thus increasing the strength and stiffness of the paperboard material. Of course, too much of the stiffening additive makes the paperboard material undesirably brittle. Blending the styrene butadiene resin with a higher glass transition temperature polymer stiffening additive also provides recyclability benefits, as the paperboard material with the stiffening additive is preferably more brittle than the paperboard material with just the styrene butadiene resin, and thus breaks up more easily during recycling of the paperboard material. Additionally, there is less flake rejection when the stiffening additive is blended into the strengthening agent composition. Addition of the stiffening agent also imparts reduced thermal blocking properties to the strengthening agent blend, as the glass transition temperature or melting point of the stiffening agent, again preferably polystyrene pigment, is higher than that of the styrene butadiene resin. As a result, the strengthening agent is less tacky, and thus is less likely to encounter sticking or tacking issues when exposed to heat.

Notably, while the strengthening agent blend including the stiffening additive may be used in numerous types of paperboard materials, it has been found most effective in liner board, which is less absorbent and less easily penetrated as compared to corrugating medium.

An additional sizing additive in the form of a water resistance additive may also be used in combination with the strengthening agent to improve the overall properties of the paperboard material. The water resistance additive may be used in combination with just the styrene butadiene resin, or in combination with the styrene butadiene resin-sizing agent blend. The water resistance additive, such an alkyl ketene dimer sizing agent, is preferably added to the strengthening agent composition in approximately 1-2 wt. % based on the dry weight of the styrene butadiene resin, in order to improve water resistance of the paperboard material. While the water resistance additive is preferably an alkyl ketene dimer purchased from Hercules Inc. of Wilmington, Del. under the brand name “Hercon 70”, other water resistant additives are also contemplated for use with the present invention, including but not limited to various rosins and alkyl succinic anhydrides. Water resistance additives are particularly preferred when the paperboard material is intended for high humidity or water exposure applications.

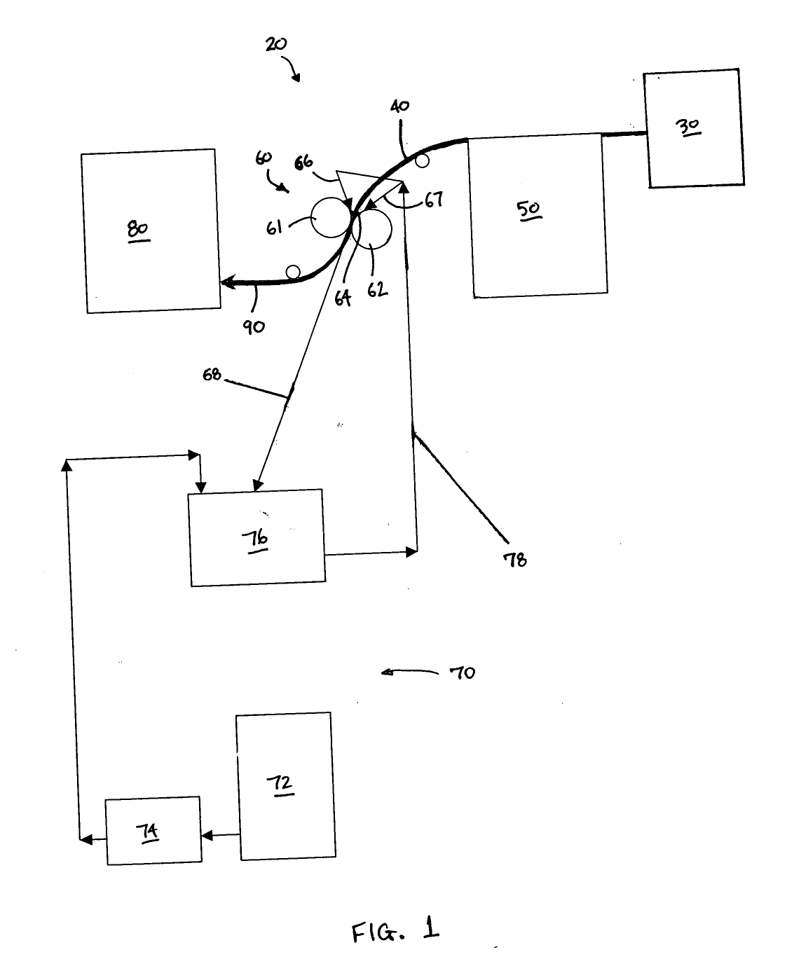

The present invention is also directed to a process for manufacturing paperboard having increased strength. In particular, process 20 is shown in FIG. 1 as comprising front end of the process for forming the paperboard 30, paper material web 40, main dryer 50, strengthening agent applicator 60, strengthening agent supply system 70 and after dryer 80. The front end of the process for forming paperboard 30 is a conventional front end for forming a web of paperboard from paper pulp, as would be known by those with ordinary skill in the art. Notably, the present process of impregnating a paperboard material with a strengthening agent preferably occurs on the dry end of the process, after the paperboard material has been formed and at least substantially dried. While paperboard material may contain some amount of water, the present process is contemplated for use with substantially dry paperboard material (typically containing between 0% and about 10% water content), after it has been formed by front end 30 and is dried in main dryer 50, as would be known by those with ordinary skill in the art with the present disclosure before them. This ensures that there is better retention of strengthening agent in the paperboard material, as it is less likely to be lost from a wet sheet during the formation and drying process. It is well known that during the formation of the paperboard sheet, the sheet is weak until it is substantially formed and substantially dry. As the present invention contemplates small particle size styrene butadiene resin impregnated into the paperboard material, those small polymer particles can be difficult to retain at a high efficiency rate in substantially wet paper.

Strengthening agent applicator 60 preferably comprises a size press. Preferably, the size press is a pond size press, although a metering size press is also contemplated for use with the present invention. As shown in FIG. 1, the size press comprises size press rollers 61 and 62, nip 64, feed lines 66 and 67 and return line 68. The strengthening agent, whether the styrene butadiene resin emulsion by itself, the styrene butadiene resin blend with a stiffening additive such as a polystyrene pigment, or either one of the above styrene butadiene emulsions in combination with a water resistance additive, is preferably pumped through feed lines 66 and 67 into nip 64. The paper material web 40 is fed into and between size press rollers 61 and 62, which size press rollers impregnate the strengthening agent into one or both sides of the paper web, depending of whether single sided or double sided impregnation is desired. Of course, those with ordinary skill in the art with the present disclosure before them will appreciate differences in size press equipment set-up to achieve either single sided or double sided impregnation. The strengthening agent which is not impregnated into paper web 40 exits rollers 61 and 62 and is returned to strengthening agent supply system 70.

The strengthening agent may also be applied by alternative standard paper making equipment. For instance, the size press may be replaced by water boxes with a calendar roll. In another alternative embodiment, the size press may be replaced by an impregnators which preferably performs the impregnation of the strengthening agent off-line, whereby the paper material sheet is passed under a liquid bath and through squeegee rollers, prior to entering the dryer. In any of these strengthening agent application systems, it is preferred that some roll-based pressure is applied to drive the strengthening agent into the paperboard material. Of course, the type of paperboard material may also dictate the amount of pressure that is required. For instance, while the more porous corrugating medium may potentially be impregnated with the strengthening agent without the use of pressure, such as by a knife coater or a blade coater, the less porous liner board typically requires some pressure from the application system to drive the styrene butadiene resin emulsion beyond just the surface of the paperboard material and into the paper fibers. Of course, those with ordinary skill in the art with the present disclosure before them will appreciate that heat may be desirable during the impregnation process, and that other types of paperboard materials may actually require some addition of heat to achieve satisfactory impregnation of the styrene butadiene resin into the paper. Specifically, the addition of heat may decrease viscosity of the emulsion solution, thus improving penetration.

Strengthening agent supply system 70 preferably includes supply tank 72, dilution tank 74, emulsion tank 76 and supply line 78. The styrene butadiene resin emulsion is preferably purchased in emulsion form, with approximately 50% solids loading. The 50% solid emulsion is diluted in dilution tank 74, before entering the emulsion tank 76. Emulsion tank 76 both feeds strengthening agent applicator system 60, as well as receives a return styrene butadiene resin from the strengthening agent applicator system. Preferably, the styrene butadiene resin comprises approximately 10-25% solids in the emulsion tank, for feeding into strengthening agent applicator system 60.

After undergoing impregnation and exiting size press rollers 61 and 62, impregnated paper web 90 enters after dryer 80, where dryer cans operating at approximately 250° C.-300° C. dry the impregnated web. Notably, each of the strengthening agent alternative embodiments, such as the strengthening agent alone or the strengthening agent blend including the stiffening additive, with or without the water resistant additive, are preferably applied in the same manner.

The following examples are given to illustrate the paperboard materials of the present invention, but are not intended to limited the invention to the examples included herewith. The following examples below illustrate exemplary strengthening agents particle sizes and formulations, but it is to be understood that the examples are presented by means of illustration only and that paperboard materials having strengthening agents impregnated therein fall within the scope of the present invention and the claims herewith may be readily produced by one skilled in the art with the present disclosure before them.

### EXAMPLE 1

The effect of styrene butadiene resin particle size on paperboard strength was tested on both liner board and corrugating medium. For the tests, liner board and corrugated medium having no styrene butadiene resin impregnation were tested against liner board and corrugating medium impregnated with styrene butadiene resin having a particle size of both 1300 angstroms and 700 angstroms. Because of standard deviations of approximately 100 angstroms in the styrene butadiene particle size resins, the 1300 angstrom styrene butadiene resin contains particles ranging from about 1200 to about 1400 angstroms, while the 700 angstrom styrene butadiene resin contains particles ranging from about 600 to about 800 angstroms.

For the tests, a one-sided small (12″ wide) lab coater was used. The lab coater was run as a single-sided metering press. The respective 1300 angstrom and 700 angstrom styrene butadiene resin emulsions were metered with a rod onto a rubber covered roll, which then contacted the paper sheet before passing through a lightly loaded nip against another rubber covered roll. The speed of the rolls was approximately 20-25 meters per minute, and the temperature was approximately 25° C. The styrene butadiene resin emulsions had a solid content of approximately 25% solids.

The results in Table 1 correspond to those obtained for the liner board, while the results in Table 2 correspond to those obtained for the corrugating medium. The caliper corresponds to the thickness of the board. The density is measured by dividing the basis weight of the board by the board thickness or caliper. The thickness of the treated layer measures the penetration of the styrene butadiene resin into the paperboard material, and was measured by removing the untreated portions of the paper material from the treated portions, thus isolating the treated portions for measurement. The CD STFI stiffness measurements are the standard measure of the cross-directional stiffness of the board according to the standardized Swedish Forest Institute Test. While the thickness of the treated layer was measured only for the linerboard as described in Table 1, not for the corrugating medium, the corrugating medium was also subjected to a standard Concora Medium Test (CMT) Stiffness Test, measuring the crushing resistance of the flutes of the corrugating medium.

TABLE 1
Linerboard Test Results

| | | Caliper | | Thickness | |
|---|---|---|---|---|---|
| Strength- | Basis | (points, | | of Treated | CD STFI |
| ening | Weight | 1 point = | Density | Layer | Stiffness |
| Agent | (lbs/msf) | 0.001 in) | (lbs/point) | (in) | (lb/in) |
| None | 46.2 | 12.4 | 3.74 | 0 | 20.9 |
| 1300 | 47.5 | 12.5 | 3.81 | 0.0045 | 20.6 |
| Angstrom | | | | | |
| Styrene | | | | | |
| Butadiene | | | | | |
| Resin | | | | | |
| 700 | 46.7 | 12.4 | 3.77 | 0.0045 | 21.9 |
| Angstrom | | | | | |
| Styrene | | | | | |
| Butadiene | | | | | |
| Resin | | | | | |

TABLE 2
Corrugating Medium Test Results

| | | Caliper | | | |
|---|---|---|---|---|---|
| Strength- | Basis | (points, | | CD STFI | CMT |
| ening | Weight | 1 point = | Density | Stiffness | Stiffness |
| Agent | (lbs/msf) | 0.001 in) | (lbs/point) | (lb/in) | (lb/6 in) |
| None | 35.9 | 12.5 | 2.88 | 13.5 | 78 |
| 1300 | 37.4 | 12.4 | 3.01 | 14.6 | 84 |
| Angstrom | | | | | |
| Styrene | | | | | |
| Butadiene | | | | | |
| Resin | | | | | |
| 700 | 37.7 | 12.4 | 3.08 | 15.9 | 93 |
| Angstrom | | | | | |
| Styrene | | | | | |
| Butadiene | | | | | |
| Resin | | | | | |

From the above results, it can be seen that the stiffness, the measure of strength of the impregnated liner board and the impregnated corrugating medium, was increased with the small particle size styrene butadiene resin, with a maximum stiffness for the small particle 700 angstrom styrene butadiene resin. The results also demonstrate that impregnation of the styrene butadiene resin into both the liner board and the corrugating medium increased the basis weight of both types of paperboard material, such that both the liner board and the corrugating medium experienced increased densification due to impregnation with the styrene butadiene resin. The results also showed that the thickness of both the liner board of the medium did not appreciably change with the addition of the styrene butadiene resin, indicating that all or substantially all of the resin penetrated into both the liner board and corrugating medium, but did not remain on the surface of those paper materials. Finally, the styrene butadiene resin penetrated into the single treated surface of the liner board approximately 36% of the total thickness of the liner board material. The small particle size 700 angstrom styrene butadiene resin significantly increased the stiffness and strength of both the liner board and the corrugating medium, beyond that of both untreated board as well as beyond that of the board treated with the more conventional and larger size 1300 angstrom styrene butadiene resin emulsion.

### EXAMPLE 2

Additional testing was performed to assess the effect of blending the small particle size 700 angstrom styrene butadiene resin with other stiffening additives, such as small particle size polymer-based pigments. The blend consisted of 80-90% styrene butadiene resin emulsion having a particle size of about 700 angstroms, and 10-20% of polystyrene pigment having a particle size of 700 angstroms or less. Again, the standard deviation of approximately 100 angstroms applies to the particle size of the blend components. The styrene butadiene resin has a glass transition temperature of approximately 15-20° C., while the polystyrene pigment has a glass transition temperature of approximately 90° C.

The liner board was used in a pilot size press that was set up to run like a mill pond size press, with a 1 meter wide coater. The rollers were run at a speed of 500-1000 ft. per minute, with a 80 pounds per linear inch nip load. The process was run at 110° F., with a emulsion solid loading of 25-35% solids. Both sides of the two-sided liner board were treated with the strengthening agent blend. After treatment, the liner board was dried in air flotation dryers, prior to winding. The final results in Table 3 below describe the test results for the two-sided trials on 56 pound liner board. While the basis weight, caliper, density and CD STFI Stiffness tests are described above in relation to Example 1, the CD Ring Crush Stiffness is a standard measure of the cross-directional stiffness of the linerboard by crushing the edges of a circular paperboard cutout.

TABLE 3
Strengthening Agent Blend Test Results

| | | Caliper | | | CD Ring |
|---|---|---|---|---|---|
| Strength- | Basis | (points, | | CD STFI | Crush |
| ening | Weight | 1 point = | Density | Stiffness | Stiffness |
| Agent | (lbs/msf) | 0.001 in) | (lbs/point) | (lb/in) | (lb/6 in) |
| None | 56.2 | 14.5 | 3.87 | 34 | 127 |
| 700 | 63.1 | 14.7 | 4.30 | 42 | 206 |
| Angstrom | | | | | |
| Styrene | | | | | |
| Butadiene | | | | | |
| Resin | | | | | |
| (Unblended) | | | | | |
| 700 | 62.1 | 14.9 | 4.17 | 45 | 215 |
| Angstrom | | | | | |
| Styrene | | | | | |
| Butadiene | | | | | |
| Resin | | | | | |

The test results from Table 3 show that the blended small particle size styrene butadiene resin and polystyrene pigment increases the stiffness and strength of the liner board, as demonstrated by both the cross-directional STFI stiffness test, as well as the cross-directional ring crush test. Further test results also show that while there was a small increase in the thickness of the treated linerboard material, the thickness of the liner board did not change appreciably. Thus, substantially all of the blended small particle size styrene butadiene—polystyrene pigment strengthening agent penetrated into the liner board, with little remaining on the surface of the liner board. Further the basis weight of the impregnated liner board increased, as did its density, thus indicating retention of the strengthening agent.

1. A paperboard material having increased strength comprising:
at least one layer of paperboard material having a first side and a second side, the paperboard material also having a thickness;
a strengthening agent at least partially impregnated into at least one of the first and second sides of the paperboard material,
wherein the strengthening agent is impregnated into paperboard material which is substantially dry, and
wherein the strengthening agent comprises a styrene butadiene resin having a particle size of less than or equal to about 1000 angstroms.

2. The paperboard material of claim 1 wherein the styrene butadiene resin strengthening agent has a particle size of less than or equal to about 700 angstroms.

3. The paperboard material of claim 1 wherein the styrene butadiene resin strengthening agent has a particle size of about 700 angstroms.

4. The paperboard material of claim 1 wherein the strengthening agent is impregnated into both the first and second sides of the paperboard material.

5. The paperboard material of claim 1 wherein the strengthening agent does not substantially affect the thickness of the paperboard material as compared to the thickness of the paperboard material without impregnation of the strengthening agent.

6. The paperboard material of claim 5 wherein the strengthening agent increases the density of the paperboard material as compared to the density of the paperboard material without impregnation of the strengthening agent.

7. The paperboard material of claim 1 wherein the strengthening agent penetrates at least one of the first and second sides of the paperboard material by about 10% to about 50% of the thickness of the paperboard material.

8. The paperboard material of claim 7 wherein the strengthening agent penetrates at least one of the first and second sides of the paperboard material by about 20% to about 50% of the thickness of the paperboard material.

9. The paperboard material of claim 8 wherein the strengthening agent penetrates at least one of the first and second sides of the paperboard material by about 35% of the thickness of the paperboard material.

10. The paperboard material of claim 1 wherein the at least one layer of paperboard material comprises liner board.

11. The paperboard material of claim 1 wherein the at least one layer of paperboard material comprises a corrugating medium.

12. The paperboard material of claim 1 wherein the strengthening agent has a glass transition temperature of about 15° C. to about 20° C.

13. The paperboard material of claim 1 wherein the strengthening agent increases the stiffness of the paperboard material.

14. The paperboard material of claim 1 wherein the strengthening agent further comprises a stiffening additive.

15. The paperboard material of claim 14 wherein the stiffening additive comprises a polystyrene resin.

16. The paperboard material of claim 15 wherein the polystyrene resin has a particle size of less than or equal to about 700 angstroms.

17. The paperboard material of claim 15 wherein the polystyrene resin is a polystyrene pigment.

18. The paperboard material of claim 14 wherein the stiffening additive has a glass transition temperature of about 70° C. to about 100° C.

19. The paperboard material of claim 18 wherein the stiffening additive has a glass transition temperature of about 80° C. to about 90° C.

20. The paperboard material of claim 19 wherein the stiffening additive has a glass transition temperature of about 90° C.

21. The paperboard material of claim 15 wherein the strengthening agent comprises:
about 80% to about 90% by weight of the styrene butadiene resin having a particle size of less than or equal to about 1000 angstroms, and
about 10% to about 20% by weight of the stiffening additive.

22. The paperboard material of claim 21 wherein the stiffening additive comprises a polystyrene resin.

23. The paperboard material of claim 1 wherein the strengthening agent further comprises a water resistance additive.

24. The paperboard material of claim 23 wherein the water resistance additive is present in an amount of about 1 wt. % to about 2 wt. % based upon the dry weight of the styrene butadiene resin.

25. The paperboard material of claim 23 wherein the water resistance additive is selected from the group consisting of alkyl ketene dimers, rosins and alkyl succinic anhydrides.

26. The paperboard material of claim 25 wherein the water resistance additive comprises an alkyl ketene dimer.

27. A method for manufacturing paperboard having increased strength comprising the following steps:
impregnating at least one side of a paperboard material having a first side and a second side with a strengthening agent, the first and second sides each having a surface and the paperboard material also having a thickness,
the strengthening agent penetrating at least one side of the paperboard material to a depth below the surface of at least one of the first and second sides,
the step of impregnating the paperboard material occurring after the paperboard material is substantially dry,
wherein the strengthening agent comprises a styrene butadiene resin having a particle size of less than or equal to about 1000 angstroms.

28. The method of claim 27 wherein the step of impregnating the paperboard material is carried out with a size press.

29. The method of claim 27 wherein the step of impregnating the paperboard material comprises impregnating both the first and second sides of the paperboard material with the strengthening agent.

30. The method of claim 27 wherein the styrene butadiene resin strengthening agent has a particle size of less than or equal to about 700 angstroms.

31. The method of claim 27 wherein the styrene butadiene resin strengthening agent has a particle size of about 700 angstroms.

32. The method of claim 27 wherein during the step of impregnating the paperboard material, the strengthening agent penetrates below the surface of at least one of the first and second sides of the paperboard material without substantially affecting the thickness of the paperboard material as compared to the thickness of the paperboard material without impregnation of the strengthening agent.

33. The method of claim 27 wherein during the step of impregnating the paperboard material, the strengthening agent penetrates at least one of the first and second sides of the paperboard material by about 10% to about 50% of the thickness of the paperboard material.

34. The method of claim 33 wherein the strengthening agent penetrates at least one of the first and second sides of the paperboard material by about 20% to about 50% of the thickness of the paperboard material.

35. The method of claim 27 wherein the strengthening agent has a glass transition temperature of about 15° C. to about 20° C.

36. The method of claim 27 further including the step of diluting the styrene butadiene resin to a solids loading of about 10 wt. % to about 50 wt. % prior to the step of impregnating the paperboard material with the styrene butadiene resin.

37. The method of claim 36 further including the step of diluting the styrene butadiene resin to a solids loading of about 10 wt. % to about 25 wt. % prior to the step of impregnating the paperboard material with the styrene butadiene resin.

38. The method of claim 27 wherein the strengthening agent further comprises a stiffening additive.

39. The method of claim 38 wherein the stiffening additive comprises a polystyrene resin.

40. The method of claim 39 wherein the polystyrene resin has a particle size of less than or equal to about 700 angstroms.

41. The method of claim 40 wherein the polystyrene resin is a polystyrene pigment.

42. The method of claim 38 wherein the stiffening additive has a glass transition temperature of about 70° C. to about 100° C.

43. The method of claim 42 wherein the stiffening additive has a glass transition temperature of about 80° C. to about 90° C.

44. The method of claim 43 wherein the stiffening additive has a glass transition temperature of about 90° C.

45. The paperboard material of claim 38 wherein the strengthening agent comprises:
about 80% to about 90% by weight of the styrene butadiene resin having a particle size of less than or equal to about 1000 angstroms, and
about 10% to about 20% by weight of the stiffening additive.

46. The method of claim 27 wherein the strengthening agent further comprises a water resistance additive.

47. The method of claim 46 wherein the water resistance additive is present in an amount of about 1 wt. % to about 2 wt. % based upon the dry weight of the styrene butadiene resin.
